(19) United States
(12) Patent Application Publication
(10) Pub. No.: US 2022/0109209 A1
(43) Pub. Date: Apr. 7, 2022

(54) BATTERY MODULE AND MANUFACTURING METHOD OF BATTERY MODULE

(71) Applicant: KABUSHIKI KAISHA TOSHIBA, Tokyo (JP)

(72) Inventor: Shinya TANIKAWA, Tokyo (JP)

(73) Assignee: KABUSHIKI KAISHA TOSHIBA, Tokyo (JP)

(21) Appl. No.: 17/355,935

(22) Filed: Jun. 23, 2021

(30) Foreign Application Priority Data
Oct. 1, 2020 (JP) 2020-166984

(51) Int. Cl. H01M 50/209; H01M 10/04

(52) U.S. Cl. CPC H01M 50/209; H01M 10/0481

(57) ABSTRACT

A battery module includes a battery row of a plurality of batteries, and a case. In the case, a first case member covers the battery row only from one side in a height direction and a width direction, and a second case member covers the battery row only from a side opposite to the first case member in the height direction and the width direction. Partitions of the two case members sandwich each of the batteries from both sides in an array direction. In the partition of the first case member, each of ribs is compressed by a corresponding one of batteries. A boundary between the two partitions is a dividing part that divides the two case members.

### CROSS-REFERENCE TO RELATED APPLICATIONS

This application is based upon and claims the benefit of priority from Japanese Patent Application No. 2020-166984, filed Oct. 1, 2020; the entire contents of which are incorporated herein by reference.

### FIELD

Embodiments described herein relate generally to a battery module and a manufacturing method of a battery module.

### BACKGROUND

In a battery module, a plurality of batteries are housed inside a case. Such a battery module requires each of the batteries to be firmly fixed inside the case. Further, from the viewpoint of reducing time and effort in manufacturing, it is required that an adhesive is not used for fixing each of the plurality of batteries inside the case.

In the battery module, the case is formed by connecting a plurality of case members. In assembling the battery module, for example, in a state where a plurality of batteries are inserted into one of a plurality of case members, the plurality of batteries are inserted into another case member, and then the case members are connected to each other. In such assembling of the battery module, it is required to improve the workability of work of inserting a plurality of batteries into each of the case members to thereby improve the workability of work of assembling the battery module.

### BRIEF DESCRIPTION OF THE DRAWINGS

FIG. 1 is a perspective view schematically showing an example of a battery alone used for a battery module according to an embodiment in which the battery is disassembled into components.

FIG. 2 is a perspective view schematically showing a battery module according to a first embodiment.

FIG. 3 is a perspective view schematically showing the battery module according to the first embodiment in a state where a case member (first case member) is separated from a case member (second case member).

FIG. 4 is a schematic view showing the battery module according to the first embodiment viewed from one side in a depth direction in a state where the case member (first case member) is separated from the case member (second case member).

FIG. 5 is a perspective view schematically showing the battery module according to the first embodiment in a state where a case member (second case member) is omitted.

FIG. 6 is a schematic view showing the battery module according to the first embodiment viewed from one side in a height direction in a state where the case member (second case member) is omitted.

FIG. 7 is a perspective view schematically showing the case member (first case member) of the battery module according to the first embodiment.

FIG. 8 is a schematic view showing the case member (second case member) of the battery module according to the first embodiment viewed from one side in a height direction.

FIG. 9 is a perspective view schematically showing a case member (first case member) of a battery module according to a first modification.

FIG. 10 is a schematic view showing the case member (first case member) of the battery module according to the first modification viewed from one side in a depth direction.

FIG. 11 is a schematic view showing a case member (first case member) of a battery module according to a second modification viewed from one side in a depth direction.

FIG. 12 is a schematic view showing a case member (first case member) of a battery module according to a third modification viewed from one side in a depth direction.

FIG. 13 is a perspective view schematically showing a battery module according to a fourth modification in a state where case members are separated from each other.

FIG. 14 is a perspective view schematically showing a case of the battery module according to the fourth modification in a state where the case members are separated from each other.

FIG. 15 is a perspective view, from a direction different from FIG. 14, schematically showing the case of the battery module according to the fourth modification in a state where the case members are separated from each other.

FIG. 16 is a perspective view schematically showing a battery module according to a fifth modification in a state where case members are separated from each other.

### DETAILED DESCRIPTION

According to an embodiment, a battery module includes a battery row, and a case. The battery row includes a plurality of batteries arrayed, and the battery row is housed in the case. The case includes a first case member that covers the battery row only from one side in a height direction intersecting an array direction of the battery row and a width direction intersecting both the array direction and the height direction, and a second case member that is coupled to the first case member and covers the battery row only from a side opposite to the first case member in the height direction and the width direction. The first case member includes a first partition formed to sandwich each of the batteries from both sides in the array direction, and first ribs, in which one or more of the first ribs are provided for each of the batteries, and each of the first ribs protrudes toward a corresponding one of the batteries in the first partition in a state of being compressed by the corresponding one of the batteries. The second case member includes a second partition formed to sandwich each of the batteries from both sides in the array direction, and a boundary between the second partition and the first partition is a dividing part that divides the second case member from the first case member.

Hereinafter, embodiments will be described with reference to drawings. A battery module according to an embodiment includes a plurality of batteries.

[Battery]

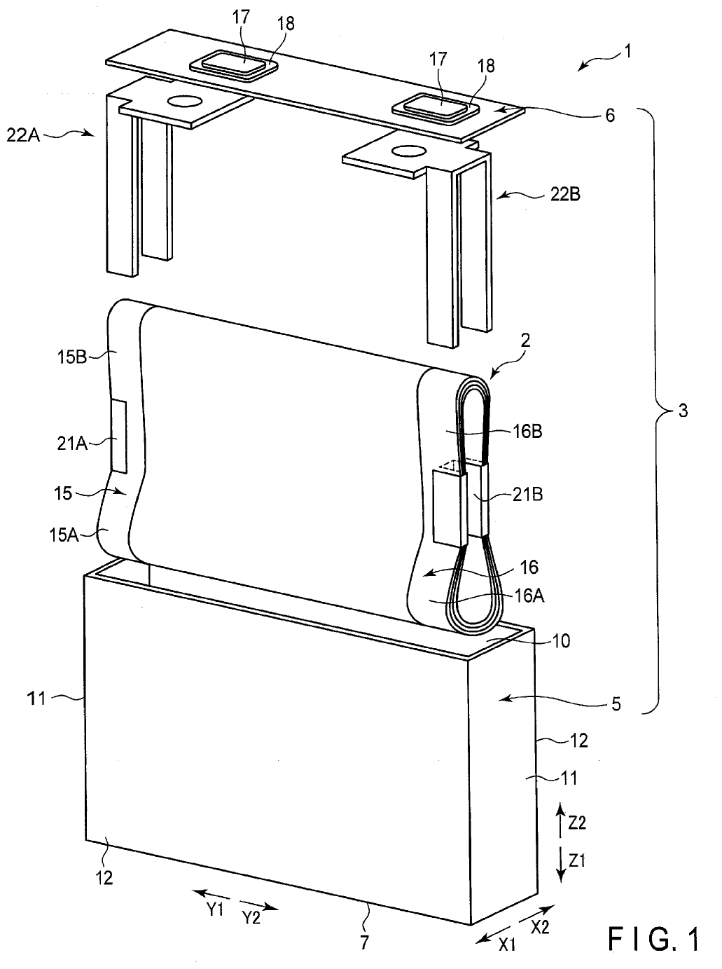

First, a battery (single cell) will be described. FIG. 1 shows an example of a battery 1 alone disassembled into components. The battery 1 includes an electrode group 2, and a container 3 in which the electrode group 2 is housed. The container 3 is made of a metal, such as aluminum, an aluminum alloy, steel, or stainless steel. The container 3 includes a container body 5, and a lid 6. The battery 1 and the container 3 are defined in terms of a depth direction (direction indicated by arrows X1 and X2), a width direction (direction indicated by arrows Y1 and Y2) intersecting (perpendicular to or substantially perpendicular to) the depth direction, and a height direction (direction indicated by arrows Z1 and Z2) intersecting (perpendicular to or substantially perpendicular to) both the depth direction and the width direction. The battery 1 and the container 3 each have a much smaller dimension in the depth direction than each of the dimension in the width direction and the dimension in the height direction.

The container body 5 includes a bottom wall 7 and two pairs of side walls 11 and 12. The bottom wall 7 and two pairs of side walls 11 and 12 define an inner cavity 10 in which the electrode group 2 is housed. In the battery 1, the inner cavity 10 is open in the height direction toward a side opposite to a side in which the bottom wall 7 is positioned. The pair of side walls 11 face each other with the inner cavity 10 interposed therebetween in the width direction. The pair of side walls 12 face each other with the inner cavity 10 interposed therebetween in the depth direction. The side walls 11 each extend along the depth direction between the side walls 12. The side walls 12 each extend along the width direction between the side walls 11. Thus, the inner cavity 10 is surrounded by the side walls 11 and 12 over the entire circumference in a circumferential direction. The lid 6 is attached to the container body 5 in the opening of the inner cavity 10. Thus, the lid 6 is attached to the side walls 11 and 12 at the end on the side opposite to the bottom wall 7. The lid and the bottom wall 7 face each other with the inner cavity 10 interposed between in the height direction.

The electrode group 2 is formed into, for example, a flat shape, and includes a positive electrode 15 and a negative electrode 16. In the electrode group 2, a separator (not shown) is interposed between the positive electrode 15 and the negative electrode 16. The separator is made of a material having electrical insulation properties, and electrically insulates the positive electrode 15 from the negative electrode 16.

The positive electrode 15 includes a positive electrode current collector 15A such as a positive electrode current collecting foil, and a positive electrode active material-containing layer (not shown) supported on a surface of the positive electrode current collector 15A. The positive electrode current collector 15A is, for example, an aluminum foil, an aluminum alloy foil, etc., and has a thickness of 10 μm to 20 μm; however, it is not limited to this. The positive electrode active material-containing layer may include a positive electrode active material, or optionally, a binder and an electro-conductive agent. Examples of the positive electrode active material include but are not limited to an oxide, a sulfide, a polymer, etc., that can occlude and release lithium ions. The positive electrode current collector 15A includes a positive electrode current collecting tab 15B as a portion not supporting the positive electrode active material-containing layer.

The negative electrode 16 includes a negative electrode current collector 16A such as a negative electrode current collecting foil, and a negative electrode active material-containing layer (not shown) supported on a surface of the negative electrode current collector 16A. The negative electrode current collector 16A is, for example, an aluminum foil, an aluminum alloy foil, a copper foil, etc., and has a thickness of 10 μm to 20 μm; however, it is not limited to this. The negative electrode active material-containing layer may include a negative electrode active material, or optionally, a binder and an electro-conductive agent. The negative electrode active material includes but is not limited to a metal oxide, a metal sulfide, a metal nitride, a carbon material, etc., that can occlude and release lithium. The negative electrode current collector 16A includes a negative electrode current collecting tab 16B as a portion not supporting the negative electrode active material-containing layer.

In the electrode group 2, the positive electrode current collecting tab 15B protrudes from the negative electrode 16. The negative electrode current collecting tab 16B protrudes from the positive electrode 15 toward a side opposite to the protruding direction of the positive electrode current collecting tab 15B. In the inner cavity 10 of the battery 1, the electrode group 2 is arranged in a state where the positive electrode current collecting tab 15B protrudes from the negative electrode 16 toward one side in the width direction. In the electrode group 2, the negative electrode current collecting tab 16B protrudes from the positive electrode 15 toward a side opposite to the side toward which the positive electrode current collecting tab 15B protrudes in the width direction of the battery 1.

Furthermore, inside the inner cavity 10, the electrode group 2 holds (is impregnated with) an electrolytic solution (not shown). The electrolytic solution may be a nonaqueous electrolytic solution obtained by dissolving an electrolyte in an organic solvent, or an aqueous electrolytic solution such as an aqueous solution. Instead of the electrolytic solution, a gel electrolyte may be used, and a solid electrolyte may be used. If a solid electrolyte is used as an electrolyte, a solid electrolyte is interposed between the positive electrode 15 and the negative electrode 16 instead of the separator in the electrode group. In this case, the solid electrolyte achieves electrical insulation between the positive electrode 15 and the negative electrode 16.

In the battery 1, a pair of electrode terminals 17 are attached to an outer surface (upper surface) of the lid 6 of the container 3. The electrode terminal 17 is made of an electro-conductive material such as a metal. One of the terminals 17 is a positive electrode terminal of the battery 1 while the other is a negative electrode terminal. An insulating member 18 is provided between each electrode terminal 17 and the lid 6. The insulating member 18 electrically insulates each electrode terminal 17 from the container 3 including the lid 6.

The positive electrode current collecting tab 15B of the electrode group 2 is electrically connected to the positive electrode terminal which is a corresponding one of the electrode terminals 17 via one or more positive electrode leads such as a backup lead 21A and a lead 22A. The negative electrode current collecting tab 16B of the electrode group 2 is electrically connected to the negative electrode terminal which is a corresponding one of the electrode terminals 17 via one or more negative electrode leads such as a backup lead 21B and a lead 22B. Each of the positive electrode lead and the negative electrode lead is made of an electro-conductive material such as a metal. Inside the inner cavity 10 of the container 3, the positive electrode current collecting tab 15B and the positive electrode lead are electrically insulated from the container 3 (the container body 5 and the lid 6) by one or more insulating members (not shown).

Inside the inner cavity 10 of the container 3, the negative electrode current collecting tab 16B and the negative electrode lead are electrically insulated from the container 3 by one or more insulating members (not shown).

In an example, the lid 6 may be provided with a gas release valve and a liquid inlet (neither shown). In this case, a sealing plate (not shown) covering the liquid inlet is welded to the outer surface of the lid 6.

[Battery Module]

Next, a battery module including a plurality of batteries such as the above-described battery 1 will be described. In the following embodiment, the battery 1 is used as a battery (single cell), but batteries used for the battery module are not limited to the battery 1. That is, the configuration of the battery module of the following embodiment can be realized even when batteries (single cells) other than the battery 1 are used.

### First Embodiment

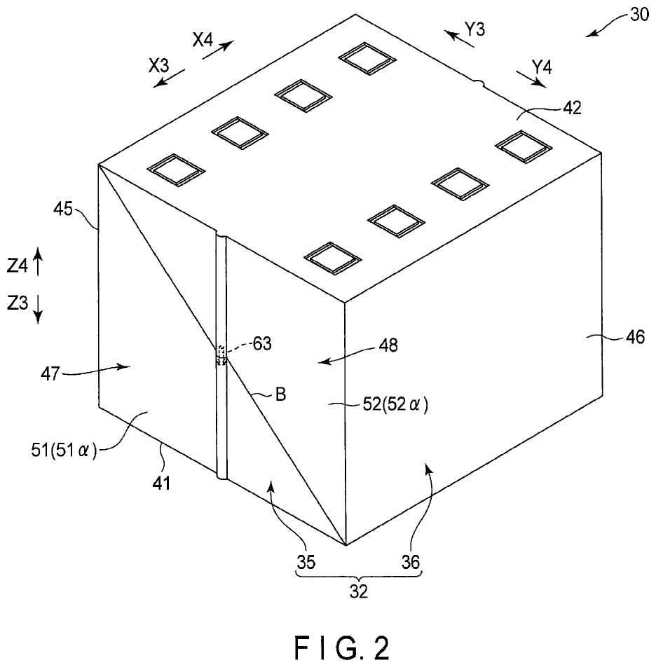

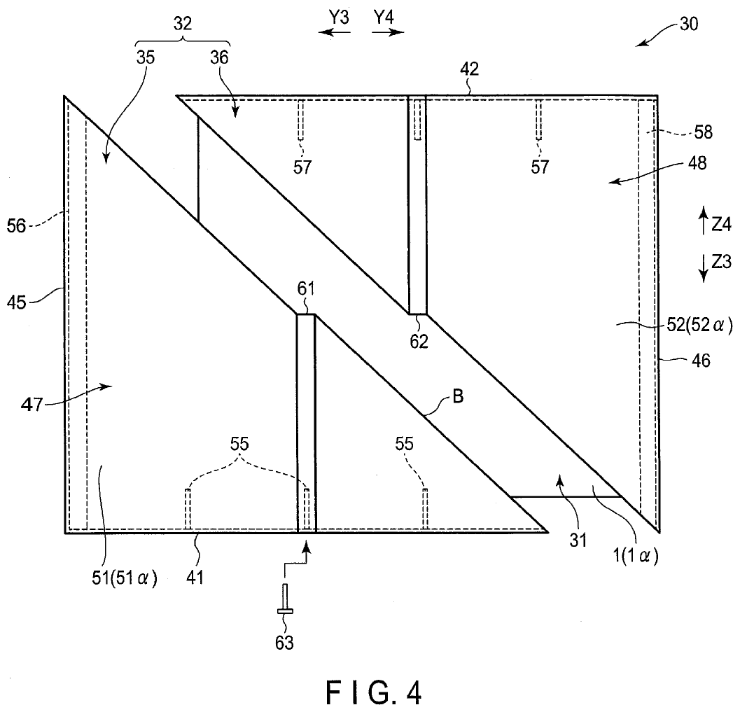

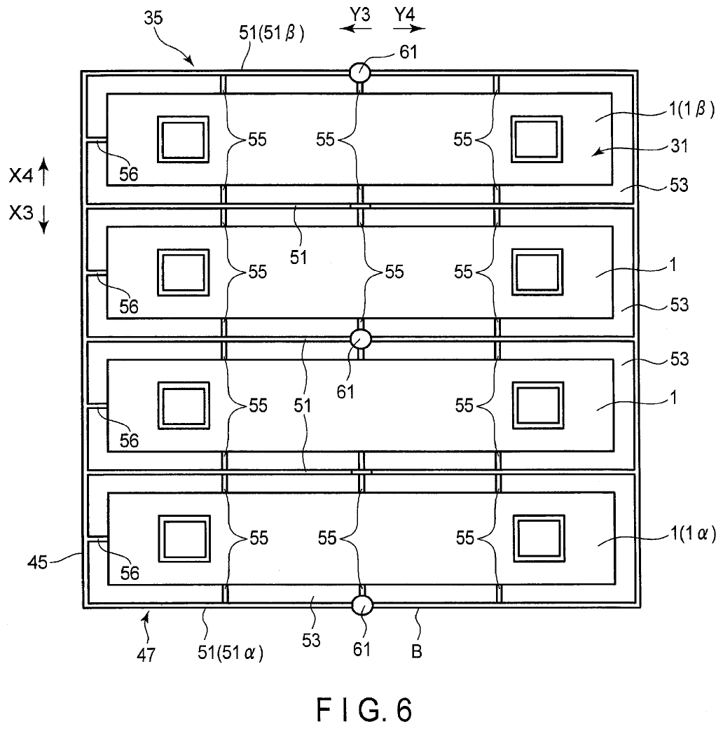

First, a battery module according to the first embodiment will be described. FIGS. 2 to 6 illustrate an example of a battery module 30 according to the first embodiment. As shown in FIGS. 2 to 6, the battery module is defined in terms of a depth direction (direction indicated by arrows X3 and X4), a width direction (direction indicated by arrows Y3 and Y4) intersecting (perpendicular to or substantially perpendicular to) the depth direction, and a height direction (direction indicated by arrows Z3 and Z4) intersecting (perpendicular to or substantially perpendicular to) both the depth direction and the width direction. FIGS. 2, 3 and 5 are perspective views, FIG. 4 illustrates a state viewed from one side in the depth direction, and FIG. 6 illustrates a state viewed from one side in the height direction.

In the battery module 30, a plurality of the aforementioned batteries 1 are provided, and in an example of FIGS. 2 to 6, four batteries 1 are provided. In the battery module 30, a row of batteries (battery row) 31 is formed in which a plurality of (four in this embodiment) batteries 1 are arrayed. An array direction of the battery row 31, i.e., a direction in which the plurality of batteries 1 are arrayed, corresponds to or substantially corresponds to the depth direction of the battery module 30. In the battery row 31, the batteries 1 are each arranged in such a manner that the depth direction corresponds to or substantially corresponds to the array direction, and the width direction corresponds to or substantially corresponds to the width direction of the battery module 30. The batteries 1 are each arranged in such a manner that the height direction corresponds to or substantially corresponds to the height direction of the battery module 30. In the battery row 31, the batteries 1 do not deviate or rarely deviate from each other in the height direction and the width direction of the battery module 30.

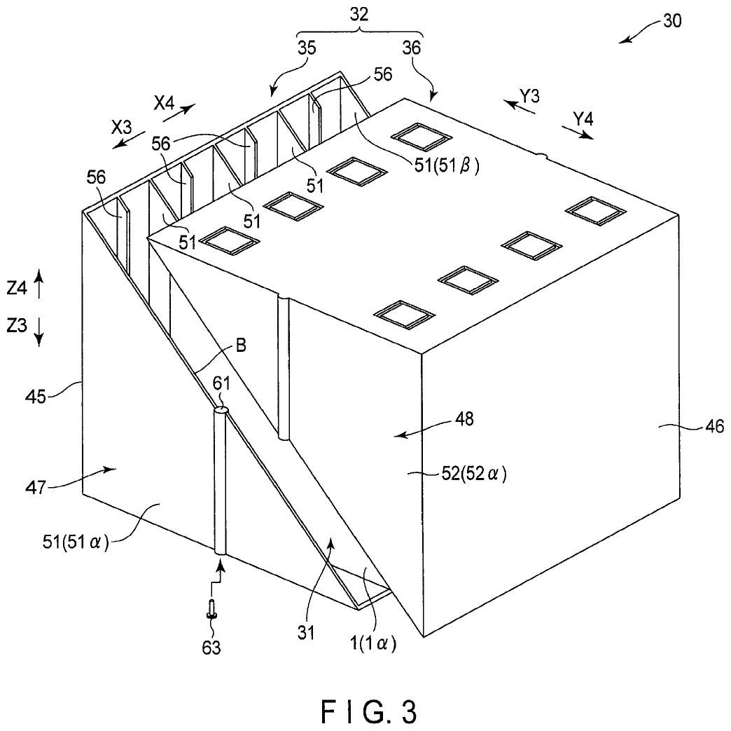

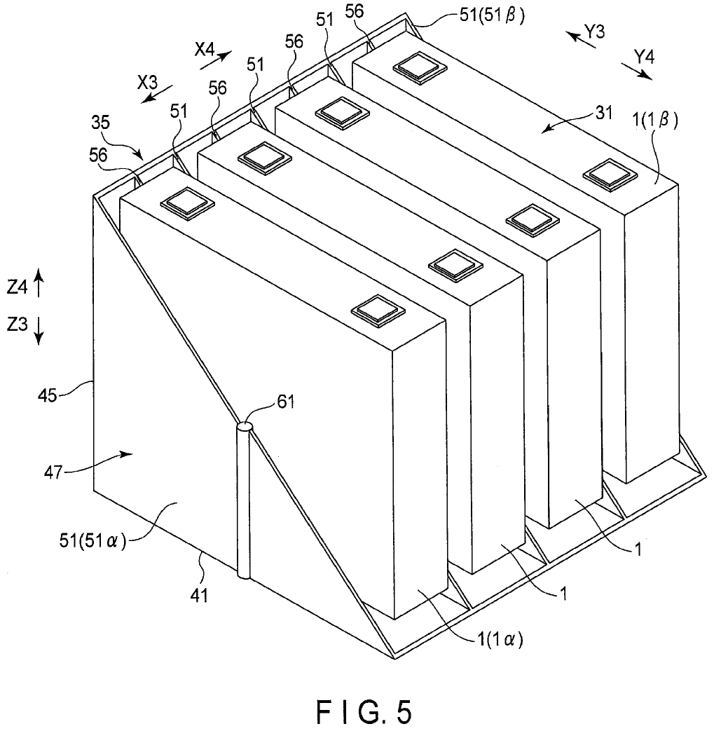

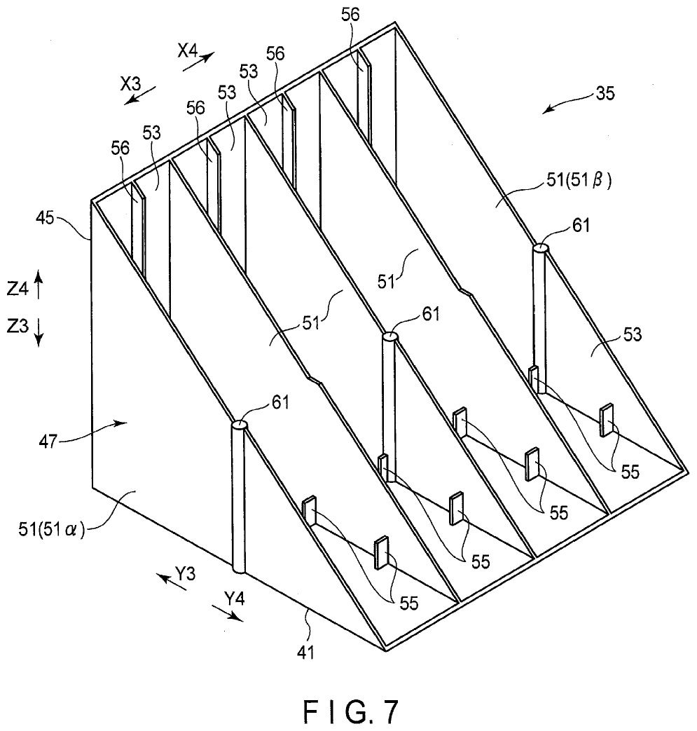

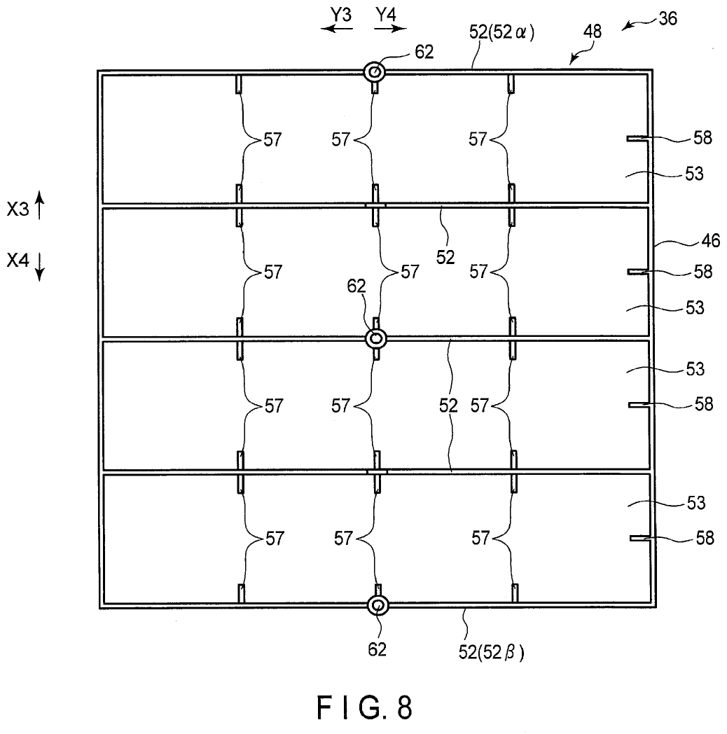

The battery module 30 includes a case 32. In the battery module 30, the battery row 31 in which the plurality of batteries 1 are arrayed is housed inside the case 32. The case 32 is made of a material having electrical insulation properties, e.g., a resin having an electrical insulation property. The case 32 includes two case members 35 and 36. In the present embodiment, by coupling the case member (first case member) 35 to the case member (second case member) 36, the case 32 is assembled. FIGS. 3 and 4 show a state where the case member 35 is separated from the case member 36. In FIGS. 5 and 6, the case member 36 is omitted. FIG. 7 is a perspective view showing the configuration of the case member (first case member) 35, and FIG. 8 shows the case member (second case member) 36 viewed from one side in the height direction.

As illustrated in FIGS. 2 to 8, etc., the case 32 includes a bottom wall 41 and a top wall 42. The bottom wall 41 covers the battery row 31 from one side in the height direction (arrow Z3 side), and is adjacent to and opposed to the battery row 31 from one side in the height direction. The top wall 42 covers the battery row 31 from a side opposite to the bottom wall 41 in the height direction (arrow Z4 side), and is adjacent to and opposed to the battery row 31 from a side opposite to the bottom wall 41 in the height direction. Thus, the bottom wall 41 and the top wall 42 are opposed to each other with the battery row 31 interposed therebetween in the height direction. Therefore, the bottom wall 41 and the top wall 42 each serve as a wall that separates the battery row 31 from the outside of the case 32 in the height direction. In the battery row 31, each of the batteries 1 is arranged in such a manner that the outer surface of the bottom wall 7 faces the side in which the bottom wall 41 is positioned in the height direction, and the outer surface of the lid 6 faces the side in which the top wall 42 is positioned in the height direction.

In the present embodiment, the bottom wall 41 is formed by the case member 35 only, and is not formed by the case member 36. The top wall 42 is formed of the case member 36 only, and is not formed of the case member 35. Thus, in the present embodiment, the case member (first case member) 35 covers the battery row 31 only from one side in the height direction (arrow Z3 side). The case member (second case member) 36 covers the battery row 31 only from the side opposite to the case member 35 in the height direction (arrow Z4 side). FIG. 8 shows the case member (second case member) 36 viewed from the side in which the case member (first case member) 35 is positioned in the height direction.

The case 32 includes a pair of side walls 45 and 46. The side wall (first side wall) 45 covers the battery row 31 from one side in the width direction (arrow Y3 side), and is adjacent to and opposed to the battery row 31 from one side in the width direction. The side wall (second side wall) 46 covers the battery row 31 from the side opposite to the side wall 45 in the width direction (arrow Y4 side), and is adjacent to and opposed to the battery row 31 from the side opposite to the side wall 45 in the width direction. Thus, the side walls 45 and 46 are opposed to each other with the battery row 31 interposed therebetween in the width direction. Therefore, the side walls 45 and 46 each serve as a wall that separates the battery row 31 from the outside of the case 32 in the width direction. The side walls 45 and 46 each extend from the bottom wall 41 to the top wall 42 along the height direction.

In the present embodiment, the side wall (first side wall) 45 is formed by only the case member 35, and is not formed by the case member 36. The side wall (second side wall) 46 is formed by only the case member 36, and is not formed by the case member 35. Thus, in the present embodiment, the case member (first case member) 35 covers the battery row 31 only from one side in the width direction (arrow Y3 side). The case member (second case member) 36 covers the battery row 31 only from the side opposite to the case member 35 (arrow Y4 side) in the width direction. In the case member 35, the side wall 45 is connected to the bottom wall 41, and extends from the bottom wall 41 toward the side in which the top wall 42 is positioned in the height direction. In the case member 36, the side wall 46 is connected to the bottom wall 42, and extends from the top wall 42 toward the side in which the bottom wall 41 is positioned in the height direction.

In the case 32, the case member (first case member) 35 includes a partition (first partition) 47, and the case member (second case member) 36 includes a partition (second partition) 48. Each of the partitions 47 and 48 is formed in such a manner that each of the batteries 1 of the battery row 31 is sandwiched from both sides in the array direction (depth direction). Thus, each of the partitions 47 and 48 is formed between adjacent batteries 1 of the battery rows 31 and outside (on both sides of) the battery row 31 in the array direction. In the case member 35, the partition 47 is connected to the bottom wall 41 and the side wall 45. In the case member 36, the partition 48 is connected to the top wall 42 and the side wall 46.

The partition (first partition) 47 includes a plurality of partition walls (first partition walls) 51, and the partition (second partition) 48 includes a plurality of partition walls (second partition walls) 52. Each of the number of partition walls 51 formed and the number of partition walls 52 formed is determined by adding one to the number of the batteries 1 of the battery row 31. In the example of FIGS. 2 to 8, etc., five partition walls 51 and five partition walls 52 are provided. The partition walls 51 are arranged to be apart from each other in the array direction (depth direction), and the partition walls 52 are arranged to be apart from each other in the array direction. Each of the partition walls 51 does not deviate or rarely deviates from a corresponding one of the partition walls 52 in the array direction (arrangement direction).

In the case member 35, each of the partition walls 51 is connected to the bottom wall 41 and the side wall 45. Each of the partition walls 51 extends from the bottom wall 41 to the side in which the top wall 42 is positioned in the height direction, and extends from the side wall 45 to the side in which the side wall 46 is positioned in the width direction. In the case member 36, each of the partition walls 52 is connected to the top wall 42 and the side wall 45. Each of the partition walls 52 extends from the top wall 42 to the side in which the bottom wall 41 is positioned in the height direction, and extends from the side wall 46 to the side in which the side wall 45 is positioned in the width direction.

Batteries 1α and 1β disposed on the outermost sides in the array direction in the battery row 31 are defined. A partition wall 51a which is one of the partition walls 51 and a partition wall 52a which is one of the partition walls 52 are opposed to and adjacent to the battery 1α from the outside in the array direction. Thus, the partition walls 51a and 52a are opposed to and adjacent to the battery row 31 from one side (arrow X3 side) in the array direction (depth direction). The partition walls 51a and 52a form a wall that covers the battery row 31 from one side in the array direction (depth direction). The wall formed by the partition walls 51a and 52a extends from the bottom wall 41 to the top wall 42 in the height direction, and extends from the side wall 45 to the side wall 46 in the width direction. The wall formed by the partition walls 51α and 52α separates the battery 1α from the outside of the case 32 in the array direction.

Another partition wall 51β different from the partition wall 51α and another partition wall 52β different from the partition wall 52α are opposed to and adjacent to the battery 1β from the outside in the array direction. Thus, the partition walls 51β and 52β are opposed to and adjacent to the battery row 31 from the side opposite to the partition walls 51α and 52α (arrow X4 side) in the array direction (depth direction). The partition walls 51β and 52β form a wall that covers the battery row 31 from the side opposite to the partition walls 51α and 52α in the array direction. The wall formed by the partition walls 51β and 52β extends from the bottom wall 41 to the top wall 42 in the height direction, and extends from the side wall 45 to the side wall 46 in the width direction. The wall formed by the partition walls 51β and 52β separates the battery 1β from the outside of the case 32 in the array direction. Thus, each of the wall formed by the partition walls 51α and 52α and the wall formed by the partition walls 51β and 52β separates the battery row 31 from the outside of the case 32 in the array direction (arrangement direction).

Between the batteries 1 adjacent in the array direction in the battery row 31, a wall is formed by a corresponding one of the partition walls 51 other than the partition walls 51α and 51β and a corresponding one of the partition walls 52 other than the partition walls 52α and 52β. A wall formed between the adjacent batteries 1 in the array direction extends from the bottom wall 41 to the top wall 42 along the height direction, and extends from the side wall 45 to the side wall 46 in the width direction. In the battery row 31, the batteries 1 adjacent in the array direction are separated by a wall formed by a corresponding one of the partition walls 51 other than the partition walls 51α and 51β and a corresponding one of the partition walls 52 other than the partition walls 52α and 52β.

Since the partitions 47 and 48 are formed as described above, spaces 53 of a number equal to the number of batteries 1 are formed at a portion where the battery row 31 is housed inside the case 32. The spaces 53 are separated from each other and separated from the outside of the case 32 by the partitions 47 and 48. In an example of FIGS. 2 to 8, four spaces 53 are formed at a portion where the battery row 31 is housed. In each space 53, a corresponding one of the batteries 1 is arranged.

In the case 32, a boundary between the partitions 47 and 48 is a dividing part B that divides the case member (second case member) 36 from the case member (first case member) 35. That is, the dividing part B of the case members 35 and 36 is formed at the boundary between each partition wall (first partition wall) 51 and a corresponding one partition wall (second partition wall) 52. Thus, the dividing part B is formed between the adjacent batteries 1 of the battery row 31 and outside (on both sides of) the battery row 31 in the array direction. However, the dividing part B is not formed at each of the side walls 45 and 46 that cover the battery row 31 from the outside in the width direction.

In the present embodiment, the boundary between the partitions 47 and 48, i.e., the dividing part B of the case members 35 and 36, extends along a direction inclined with respect to both of the height direction and the width direction of the battery module 30. The dividing part B is formed from a boundary part with the side wall (first side wall) 45 of the top wall 42 to a boundary part with the side wall (second side wall) 46 of the bottom wall 41. The dividing part B is formed in such a manner that it becomes more distant from the side wall 45 in the width direction as it comes closer to the bottom wall 41 in the height direction. That is, the dividing part B is formed in such a manner that it comes closer to the side wall 46 in the width direction as it is further away from the top wall 42 in the height direction. In an example of FIGS. 2 to 8, when viewed from the array direction (depth direction), the dividing part B is linear or substantially linear along a direction inclined with respect to both the height direction and the width direction.

The partition (first partition) 47 of the case member (first case member) 35 is provided with a plurality of ribs (first ribs) 55. One or more ribs 55 are formed for each of the batteries 1 of the battery row 31. In the present embodiment, the ribs 55 are formed on each of the surfaces facing the inner side in the array direction in the partition walls 51α and 51β, and on each of both surfaces facing the array direction in the partition walls other than the partition walls 51α and 51β. In an example of FIGS. 2 to 8, three ribs 55 are formed on each of the surfaces facing the inner side in the array direction in the partition walls 51α and 51β, and on each of both surfaces facing the array direction in the partition walls 51 other than the partition walls 51α and 51β. Thus, six ribs 55 are arranged in each of the four spaces 53, and six ribs 55 are provided for each battery 1.

Each rib 55 protrudes toward a corresponding one of the batteries 1 in the partition 47. The protrusion direction of each rib 55 corresponds to or substantially corresponds to the depth direction of the battery module (array direction of the battery row 31). Each rib 55 is compressed by a corresponding one of the batteries 1. In the present embodiment, a plurality of ribs 55 are formed on each of the surfaces facing the inner side in the array direction in the partition walls 51α and 51β, and on each of both surfaces facing the array direction in the partition walls 51 other than the partition walls 51α and 51β. The ribs 55 are positioned apart from each other in the width direction of the battery module 30 on each of the surfaces facing the inner side in the array direction in the partition walls 51α and 51β, and on each of both surfaces facing the array direction in the partition walls 51 other than the partition walls 51α and 51β. One or more ribs (first ribs) 55 are arranged at a position deviated with respect to other ribs 55 in the width direction of the battery module 30.

Each of the ribs 55 is defined in terms of a length direction intersecting (perpendicular to or substantially perpendicular to) the protruding direction, and a thickness direction intersecting (perpendicular to or substantially perpendicular to) both the protruding direction and the length direction. Each of the ribs 55 has a much larger dimension along the length direction than the dimension along the thickness direction. In the present embodiment, each rib 55 is arranged in such a manner that the length direction corresponds to or substantially corresponds to the height direction of the battery module 30. That is, the length direction of each rib 55 intersects the width direction of the battery module 30, and is perpendicular to or substantially perpendicular to the width direction of the battery module 30. The thickness direction of each rib 55 corresponds to or substantially corresponds to the width direction of the battery module 30. In the partition 47, each rib 55 is formed at an end portion on a side in which the bottom wall 41 is positioned in the height direction of the battery module 30. One end in the length direction of each rib 55 is connected to the bottom wall 41.

A plurality of ribs (second ribs) 56 are formed on the side wall (first side wall) 45 of the case member (first case member) 35. One or more ribs 56 are formed for each of the batteries 1 of the battery row 31. In the present embodiment, the ribs 56 are formed on the surface facing the inner side in the width direction in the side wall 45. In an example of FIGS. 2 to 8, one rib 56 is arranged in each of the four spaces 53, and one rib 56 is provided for each of the batteries 1. Each rib 56 protrudes in the side wall 45 toward a corresponding one of the batteries 1, and each rib 56 protrudes toward the inner side in the width direction of the battery module 30. Each rib 56 is compressed by a corresponding one of the batteries 1.

Each of the ribs 56 is defined in terms of a length direction and a thickness direction in addition to the protrusion direction. Each of the ribs 56 has a much larger dimension along the length direction than the dimension along the thickness direction. In the present embodiment, each rib 56 is arranged in such a manner that the length direction corresponds to or substantially corresponds to the height direction of the battery module 30. The thickness direction of each rib 56 corresponds to or substantially corresponds to the array direction of the batteries 1. In the side wall 45, each rib 56 is formed from the bottom wall 41 to the top wall 42 in the height direction of the battery module 30. One end in the length direction of each rib 56 is connected to the bottom wall 41.

The partition (second partition) 48 of the case member (second case member) 36 is provided with a plurality of ribs (third ribs) 57. One or more ribs 57 are formed for each of the batteries 1 of the battery row 31. In the present embodiment, the ribs 57 are formed on each of the surfaces facing the inner side in the array direction in the partition walls 52α and 52β, and on each of both surfaces facing the array direction in the partition walls 52 other than the partition walls 52α and 52β. In an example of FIGS. 2 to 8, six ribs 57 are provided for each battery 1 in a manner similar to the ribs 55.

Each rib 57 protrudes toward a corresponding one of the batteries 1 in the partition 48. The protrusion direction of each rib 57 corresponds to or substantially corresponds to the depth direction of the battery module (array direction of the battery row 31). Each rib 57 is compressed by a corresponding one of the batteries 1. In the present embodiment, a plurality of ribs 57 are formed on each of the surfaces facing the inner side in the array direction in the partition walls 52α and 52β, and on each of both surfaces facing the array direction in the partition walls 52 other than the partition walls 52α and 52β. The ribs 57 are positioned apart from each other in the width direction of the battery module 30 on each of the surfaces facing the inner side in the array direction in the partition walls 52α and 52β, and on each of both surfaces facing the array direction in the partition walls 52 other than the partition walls 52α and 52β.

Each of the ribs 57 is also defined in terms of a length direction and a thickness direction in addition to the protrusion direction. Each of the ribs 57 has a much larger dimension along the length direction than the dimension along the thickness direction. In the present embodiment, each rib 57 is arranged in such a manner that the length direction corresponds to or substantially corresponds to the height direction of the battery module 30. The thickness direction of each rib 57 corresponds to or substantially corresponds to the width direction of the battery module 30. In the partition 48, each rib 57 is formed at an end portion on a side in which the top wall is positioned in the height direction of the battery module 30. One end in the length direction of each rib 57 is connected to the top wall 42.

A plurality of ribs (fourth ribs) 58 are formed on the side wall (second side wall) 46 of the case member (second case member) 36. One or more ribs 58 are formed for each of the batteries 1 of the battery row 31. In the present embodiment, the ribs 58 are formed on the surface facing the inner side in the width direction in the side wall 46. In an example of FIGS. 2 to 8, one rib 58 is provided for each battery 1 in a manner similar to the ribs 56. Each rib 58 protrudes in the side wall 46 toward a corresponding one of the batteries 1, and each rib 58 protrudes toward the inner side in the width direction of the battery module 30. Each rib 58 is compressed by a corresponding one of the batteries 1.

Each of the ribs 58 is also defined in terms of a length direction and a thickness direction in addition to the protrusion direction. Each of the ribs 58 has a much larger dimension along the length direction than the dimension along the thickness direction. In the present embodiment, each rib 58 is arranged in such a manner that the length direction corresponds to or substantially corresponds to the height direction of the battery module 30. The thickness direction of each rib 58 corresponds to or substantially corresponds to the array direction of the batteries 1. In the side wall 46, each rib 58 is formed from the bottom wall 41 to the top wall 42 in the height direction of the battery module 30. One end in the length direction of each rib 58 is connected to the top wall 42.

A hole 61 is formed in the case member 35, and in an example of FIGS. 2 to 8, three holes 61 are formed in the case member 35. Each hole 61 extends from the bottom wall to the boundary between the partitions 47 and 48 (dividing part B of the case members 35 and 36) by passing through the partition 47. In the present embodiment, each of the holes 61 is formed along the height direction of the battery module 30. Each of the holes 61 is positioned at a center part of the case member 35 in the width direction of the battery module 30. In an example of FIGS. 2 to 8, one of the holes 61 is formed from the bottom wall 41 by passing through the partition wall 51β, and another one of the holes 61 is formed from the bottom wall 41 by passing through the partition wall 51β. Another one of the holes 61 is formed from the bottom wall 41 by passing through one of the partition walls 51 other than the partition walls 51α and 51β.

The case member 36 includes holes 62 of the same number as the holes 61. Each of the holes 62 is formed in the partition 48, and extends along the height direction from the boundary between the partitions 47 and 48 (dividing part B of the case members 35 and 36). Each hole 62 is positioned at a center part of the case member 36 in the width direction of the battery module 30. In an example of FIGS. 2 to 8, one of the holes 62 is formed in the partition wall 52α, and another one of the holes 62 is formed in the partition wall 51β. Another one of the holes 62 is formed in one of the partition walls 52 other than the partition walls 52α and 52β. Each of the holes 62 is formed coaxially or substantially coaxially with respect to a corresponding one of the holes 61, and communicates with a corresponding one of the holes 61. Each hole 62 has a cross-sectional area smaller than that of each hole 61.

The battery module 30 is provided with fastening screws 63 of the same number as the holes 61 (i.e., the same number as the holes 62) as fastening members. The case member 35 is fastened to the case member 36 by the fastening screw 63, and is thereby coupled to the case member 36. Each fastening screw 63 is inserted into a corresponding one of the holes 61. Each fastening screw 63 is engaged with the partition 48 of the case member 36 by being threaded, etc. in a state where the head portion is positioned in a corresponding one of the holes 61. Each fastening screw 63 is engaged with the partition 48 at a corresponding one of the holes 62. By engagement of each fastening screw 63 with the partition 48 as described above, the case member 35 is fastened to the case member 36. One of the fastening screws 63 is engaged with the partition wall 52α, and another one of the fastening screws 63 is engaged with the partition walls 52β. Another one of the fastening screws 63 is engaged with one of the partition walls 52 other than the partition walls 52α and 52β.

Since each of the holes 61 and 62 is formed in the height direction of the battery module 30, each of the fastening screws 63 is engaged with the partition 48 in a state where an axis direction corresponds to or substantially corresponds to the height direction of the battery module 30. Thus, a direction in which a fastening force of each fastening screw 63 is applied corresponds to or substantially corresponds to the height direction of the battery module 30. Therefore, in the present embodiment, the case member (first case member) 35 is fastened to the case member (second case member) 36 in a state where the fastening force of the fastening screw 63 is applied in a direction intersecting (perpendicular to or substantially perpendicular to) the width direction of the battery module 30.

Here, assembly of the battery module 30 will be described. In assembling the battery module 30, the plurality of batteries 1 of the battery row 31 are inserted into the case member (second case member) 36. At this time, the batteries 1 are inserted into the case member 36 in such a manner that the case member 36 covers the battery row 31 only from one side in each of the height direction and the width direction of the battery module 30. As a result, the battery row 31 is covered with the top wall 42 from one side in the height direction (arrow Z4 side) of the battery row 30, and covered with the side wall (second side wall) 46 from one side in the width direction (arrow Y4 side) of the battery module 30. Furthermore, the batteries 1 are inserted into the case member 36 in such a manner that the partition (second partition) 48 of the case member 36 sandwiches each of the batteries 1 from both sides in the array direction of the battery row 31.

The batteries 1 of the battery row 31 are inserted into the case member (first case member) 35 in a state where the batteries 1 are inserted into the case member 36. At this time, the batteries 1 are inserted into the case member 35 from the end opposite to the side in which the case member 36 covers in the width direction of the battery module 30. The batteries 1 are inserted inside the case member 35 along the width direction of the battery module 30. Thus, in the present embodiment, the direction in which the batteries 1 of the battery row 31 are inserted into the case member (first case member) 35 corresponds to or substantially corresponds to the width direction of the battery module 30.

Furthermore, the batteries 1 of the battery row 31 are inserted into the case member 35 in such a manner that the partition (first partition) 47 of the case member 35 sandwiches each of the batteries 1 from both sides in the array direction of the battery row 31. Thus, by inserting the batteries 1 into the case member 35, each of the ribs (first ribs) 55 is compressed by a corresponding one of the batteries 1. The batteries 1 are inserted into the case member 35 until each of the ribs (second ribs) 56 is compressed by a corresponding one of the batteries 1.

In a state where the batteries 1 are inserted into the case member 35 as described above, the case members 35 and 36 are fastened with the fastening screw 63, thereby the case members 35 and 36 are coupled. In this manner, the case 32 is assembled. In a state where the case 32 is assembled, the case member 35 covers the battery row 31 only from the side opposite to the case member 36 in each of the height direction and the width direction of the battery module 30. As a result, the battery row 31 is covered with the bottom wall 41 from the side (arrow Z3 side) opposite to the top wall 42 in the height direction of the battery row 30, and covered with the side wall (first side wall) 45 from the side (arrow Y3 side) opposite to the side wall (second side wall) 46 in the width direction of the battery module 30. In a state where the case 32 is assembled, the boundary between the partitions 47 and 48 is the dividing part B of the case members 35 and 36.

In the battery module 30 of the present embodiment, each of the ribs 55 is compressed by a corresponding one of the batteries 1. Thus, each of the batteries 1 is firmly fixed inside the case 32 by force from a corresponding one or more ribs 55. Each of ribs 56, 57 and is compressed by a corresponding one of the batteries 1. Thus, to each of the batteries 1, a force is applied from not only a corresponding one or more ribs 55 but also corresponding one or more ribs 56, corresponding one or more ribs 57, and corresponding one or more ribs 58. Therefore, each of the batteries 1 is firmly fixed inside the case 32.

Thus, without using an adhesive, each of the batteries 1 is firmly fixed inside the case 32. In particular, if an adhesive is not used to fix the batteries 1, it is possible to realize reduction in time and effort in manufacturing the battery module 30.

In the battery module 30, the case member 35 covers the battery row 31 only from one side in each of the width direction and the height direction. The case member 36 covers the battery row 31 only from the side opposite to the case member 35 in each of the width direction and the height direction. The partition 47 of the case member 35 and the partition 48 of the case member 36 are each formed to sandwich each of the batteries 1 from both sides in the array direction of the battery row 31, and the boundary between the partitions 47 and 48 is the dividing part B of the case members 35 and 36. With this configuration, it is possible to insert the batteries 1 into the case member 35 along the width direction of the battery module 30 in a state where the batteries 1 are inserted into the case member 36.

By inserting the batteries 1 into the case member 35 along the width direction of the battery module 30, the force (resistance force) applied to the battery row 31 (batteries 1) from the ribs 55, etc. is reduced as compared to when the batteries 1 are inserted into the case member 35 along the height direction of the battery module 30. Thus, it is possible to reduce a load applied to the batteries 1 when the batteries 1 are inserted into the case member 35. Therefore, the workability of work of inserting the batteries 1 into the case member 35 is improved, and the workability of work of assembling the battery module 30 is improved.

In the present embodiment, the ribs 55 and 56 each have a much larger dimension along the length direction than the dimension along the thickness direction. The ribs and 56 are each arranged in such a manner that the length direction corresponds to or substantially corresponds to the height direction of the battery module 30, and the length direction of each of the ribs 55 and 56 intersects the width direction of the battery module 30. Thus, by inserting the batteries 1 into the case member 35 along the width direction of the battery module 30, the force (resistance force) applied to the battery row 31 (batteries 1) from the ribs 55 and 56 is sufficiently reduced in inserting the batteries 1 into the case member 35.

The ribs 55 are positioned apart from each other in the width direction of the battery module 30 on each of the surfaces facing the inner side in the array direction in the partition walls 51α and 51β, and on each of both surfaces facing the array direction in the partition walls 51 other than the partition walls 51α and 51β. That is, in the present embodiment, one or more ribs (first ribs) 55 are arranged at a position deviated with respect to other ribs 55 in the width direction of the battery module 30. With this configuration, when the batteries 1 are inserted into the case member 35, it is possible to prevent all ribs 55 from being compressed simultaneously, and to prevent the force (resistance force) from all ribs 55 from starting to be applied simultaneously to the battery row 31. Therefore, the workability of work of inserting the batteries 1 into the case member 35 is improved.

In the present embodiment, the case members 35 and 36 are fastened in a state where the fastening force of the fastening screw 63 is applied in a direction intersecting (perpendicular to or substantially perpendicular to) the width direction of the battery module 30. That is, the fastening force of the fastening screw 63 is applied in a direction intersecting the insertion direction of the batteries 1 into the case member 35. Thus, when the case members 35 and 36 are fastened, the influence of the force (resistance force) applied to the batteries 1 from the ribs 55 and 56, etc. is reduced. This can reduce a load when the case members 35 and 36 are fastened, and the workability of work of assembling the case 32 is improved. Therefore, the workability of work of assembling the battery module 30 can be further improved.

(Modifications)

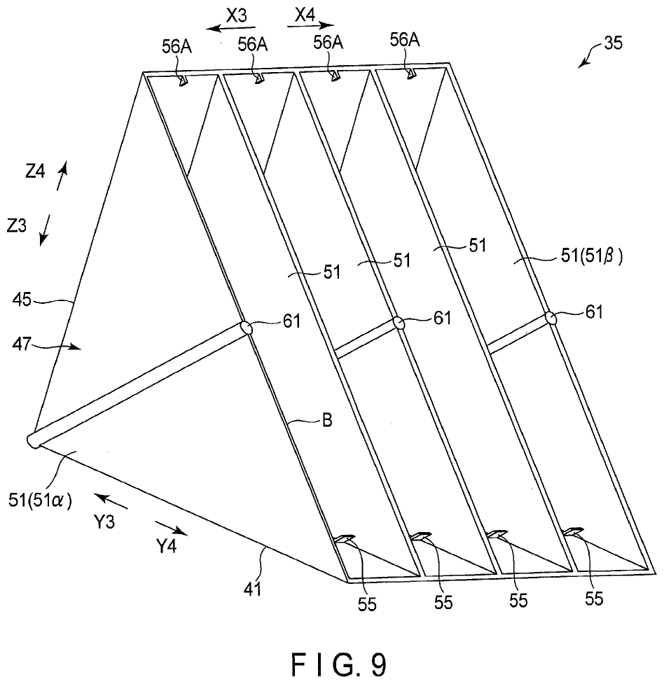

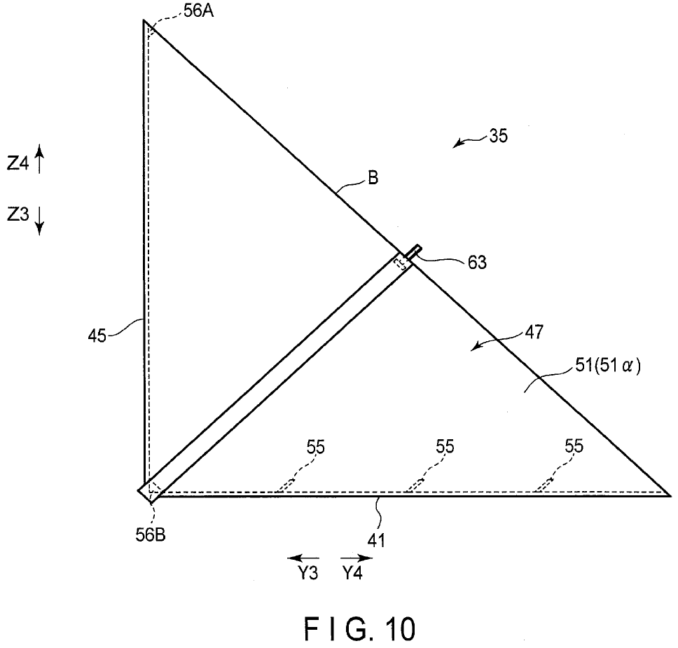

FIGS. 9 and 10 show a first modification, in which the ribs (first ribs) 55 each extend to be inclined with respect to the height direction of the battery module 30. Thus, each rib 55 is arranged in such a manner that the length direction is inclined in both the height direction and the width direction of the battery module 30. In the present modification as well, in the partition 47, each rib 55 is formed at an end portion on a side in which the bottom wall 41 is positioned in the height direction of the battery module 30, and one end in the length direction of each rib 55 is connected to the bottom wall 41. FIG. 9 is a perspective view showing the case member (first case member) 35, and FIG. 10 shows the case member 35 viewed from one side in the depth direction.

In the present modification as well, the length direction of each rib 55 intersects the width direction of the battery module 30. Thus, by inserting the batteries 1 into the case member 35 along the width direction of the battery module 30, the force (resistance force) applied to the battery row 31 (batteries 1) from the ribs 55 and 56 is sufficiently reduced in inserting the batteries 1 into the case member 35.

In the present modification, the side wall 45 is provided with ribs (second ribs) 56A and 56B instead of the ribs 56. In an example of FIGS. 9 and 10, one or more ribs 56A are formed for each of the batteries 1 of the battery row 31, and one or more ribs 56B are formed for each of the batteries 1 of the battery row 31. Each of the ribs 56A and 56B protrudes toward a corresponding one of the batteries 1, and is compressed by a corresponding one of the batteries 1, in the side wall 45. Thus, in the present modification, a force is applied to each battery 1 from a corresponding one of the ribs 56A and a corresponding one of the ribs 56B instead of the ribs 56, and each of the batteries 1 is fixed inside the case 32. Each rib 56A is formed at an end portion on a side in which the top wall 42 is positioned in the side wall 45, and each rib 56B is formed at an end portion on a side in which the bottom wall 41 is positioned in the side wall 45.

In the present modification, each of the holes 61 and 62 extends to be inclined with respect to both the height direction and the width direction of the battery module 30. The axis direction of each of the fastening screws (fastening members) 63 is inclined with respect to the height direction and the width direction of the battery module 30. Thus, the case member (first case member) 35 is fastened to the case member (second case member) 36 in such a manner that the fastening force of the fastening screw 63 is applied in a direction inclined with respect to the height direction and the width direction of the battery module 30. In the present modification as well, the fastening force of the fastening screw 63 is applied in a direction intersecting the width direction of the battery module 30. Thus, when the case members 35 and 36 are fastened, the influence of the force (resistance force) applied to the batteries 1 from the ribs 55 and 56, etc. is reduced.

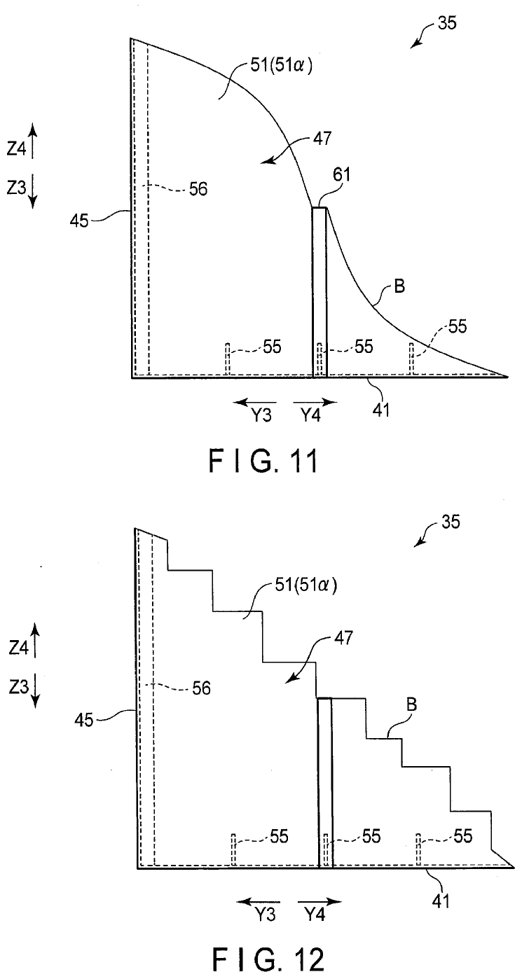

In the above-described embodiments, etc., the dividing part B of the case members 35 and 36 is linear or substantially linear when viewed from the array direction (depth direction); however, the embodiments are not limited to this. In the second modification illustrated in FIG. 11, the dividing part B of the case members 35 and 36 has, for example, an arc shape or a substantially arc shape when viewed from the array direction (depth direction), and a curved shape when viewed from the array direction. In the third modification illustrated in FIG. 12, the dividing part B of the case members 35 and 36 has a step-like shape or a substantially step-like shape when viewed from the array direction (depth direction). FIGS. 11 and 12 each show the case member 35 when viewed from one side in the depth direction.

As described above, in the second and third modifications, the dividing part B of the case members 35 and 36 is not linear or substantially linear when viewed from the array direction (depth direction). However, in all of these modifications, the boundary between the partitions 47 and 48 is the dividing part B that divides the case member (second case member) 36 from the case member (first case member) 35, and the dividing part B is not formed on the side walls 45 and 46 covering the battery row 31 from the outside in the width direction. Furthermore, in all of the modifications, the dividing part B of the case members 35 and 36 extends along the direction inclined with respect to both the height direction and the width direction of the battery module 30. The dividing part B is formed in such a manner that it becomes more distant from the side wall 45 in the width direction as it comes closer to the bottom wall 41 in the height direction. Thus, both the second modification and the third modification exhibit similar advantageous effects to those of the above-described embodiment.

The number of the batteries 1 constituting the battery row 31 is not limited as long as the battery row 31 is formed by a plurality of batteries 1. Furthermore, the number of battery rows 31 provided in the battery module 30 is not limited to one, and a plurality of battery rows 31 may be provided in the battery module 30.

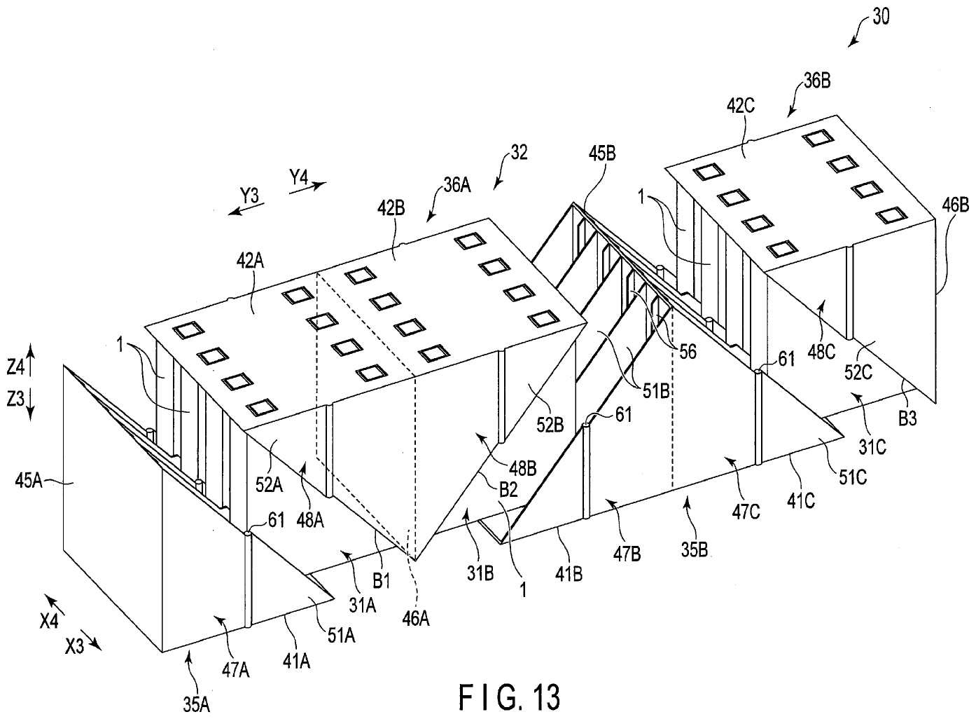

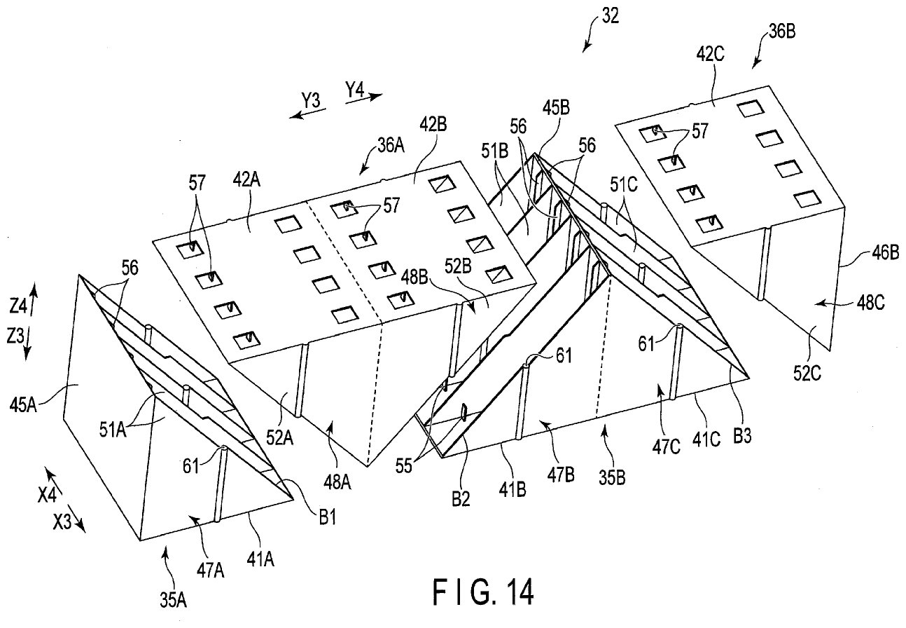

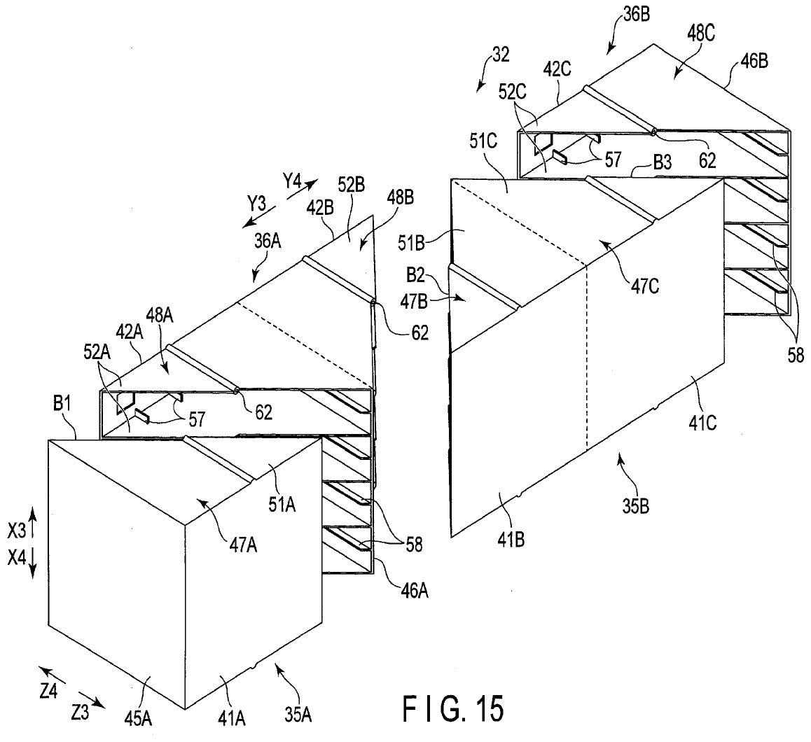

In the fourth modifications illustrated in FIGS. 13 to 15, three of battery rows 31A to 31C are provided in the battery module 30. Each of the battery rows 31A to 31C includes four batteries 1. In this modification as well, an array direction of each of the battery rows 31A to 31C corresponds to or substantially corresponds to the depth direction (direction indicated by arrows X3 and X4) of the battery module 30. FIG. 13 is a perspective view of the battery module 30, and FIGS. 14 and 15 are perspective views of the case 32. In FIGS. 14 and 15, a viewing direction differs.

In the present modification, the case 32 is formed by case members 35A, 35B, 36A, and 36B. The case member 35A includes a bottom wall 41A, a side wall 45A, and a partition 47A, and the partition 47A includes five partition walls 51A. The case member 35B includes bottom walls 41B and 41C, a side wall 45B, and partitions 47B and 47C. The partition 47B includes five partition walls 51B, and the partition 47C includes five partition walls 51C. The case member 36A includes top walls 42A and 42B, a side wall 46A, and partitions 48A and 48B. The partition 48A includes five partition walls 52A, and the partition 48B includes five partition walls 52B. The case member 36B includes a top wall 42C, a side wall 46B, and a partition 48C, and the partition 48C includes five partition walls 52C. FIGS. 13 to 15 show a state in which the case members 35A, 35B, 36A, and 36B are separated from each other.

The bottom wall 41A covers the battery row 31A from one side in the height direction (arrow Z3 side), and the top wall 42A covers the battery row 31A from the side opposite to the bottom wall 41A in the height direction (arrow Z4 side). The side wall (first side wall) 45A covers the battery row 31A from one side in the width direction (arrow Y3 side), and the side wall (second side wall) 46A covers the battery row 31A from the side opposite to the side wall 45A in the width direction (arrow Y4 side). The case member (first case member) 35A covers the battery row 31A only from one side in each of the height direction and the width direction, and the case member (second case member) 36A covers the battery row 31A only from the side opposite to the case member 35A in each of the height direction and the width direction.

Each of the partition (first partition) 47A and the partition (second partition) 48A is formed to sandwich each of the batteries 1 of the battery row 31A from both sides in the array direction (depth direction). Thus, each battery 1 of the battery row 31A is sandwiched by corresponding two partition walls (first partition walls) 51A from both sides in the array direction, and sandwiched by corresponding two partition walls (second partition walls) 52A from both sides in the array direction. The boundary between the partitions 47A and 48A is a dividing part B1 that divides the case member (second case member) 36A from the case member (first case member) 35A. The dividing part B1 of the case members 35A and 36A extends along a direction inclined with respect to both the height direction and the width direction of the battery module 30. The dividing part B1 is formed in such a manner that it becomes more distant from the side wall 45A in the width direction as it comes closer to the bottom wall 41A in the height direction.

In the present modification, the partition 47A is provided with ribs (first ribs) 55 in a manner similar to the above-described embodiments, etc. The batteries 1 of the battery row 31A are inserted into the case member 35A along the width direction of the battery module 30 in a state of being inserted into the case member 36A. Therefore, the workability of work of inserting the batteries 1 of the battery row 31A into the case member 35A is improved in a manner similar to the above-described embodiments, etc.

In the present modification, the bottom wall 41B covers the battery row 31B from one side in the height direction (arrow Z3 side), and the top wall 42B covers the battery row 31B from the side opposite to the bottom wall 41B in the height direction (arrow Z4 side). The side wall (first side wall) 45B covers the battery row 31B from one side in the width direction (arrow Y4 side), and the side wall (second side wall) 46A covers the battery row 31B from the side opposite to the side wall 45B in the width direction (arrow Y3 side). The case member (first case member) 35B covers the battery row 31B only from one side in each of the height direction and the width direction, and the case member (second case member) 36A covers the battery row 31B only from the side opposite to the case member 35B in each of the height direction and the width direction.

Each of the partition (first partition) 47B and the partition (second partition) 48B is formed to sandwich each of the batteries 1 of the battery row 31B from both sides in the array direction (depth direction). Thus, each battery 1 of the battery row 31B is sandwiched by corresponding two partition walls (first partition walls) 51B from both sides in the array direction, and sandwiched by corresponding two partition walls (second partition walls) 52B from both sides in the array direction. The boundary between the partitions 47B and 48B is a dividing part B2 that divides the case member (second case member) 36A from the case member (first case member) 35B. The dividing part B2 of the case members 35B and 36A extends along a direction inclined with respect to both the height direction and the width direction of the battery module 30. The dividing part B2 is formed in such a manner that it becomes more distant from the side wall 45B in the width direction as it comes closer to the bottom wall 41B in the height direction.

In the present modification, the partition 47B is provided with ribs (first ribs) 55 in a manner similar to the above-described embodiments, etc. The batteries 1 of the battery row 31B are inserted into the case member 35B along the width direction of the battery module 30 in a state of being inserted into the case member 36A. Therefore, the workability of work of inserting the batteries 1 of the battery row 31B into the case member 35B is improved in a manner similar to the above-described embodiments, etc.

In the present modification, the bottom wall 41C covers the battery row 31C from one side in the height direction (arrow Z3 side), and the top wall 42C covers the battery row 31C from the side opposite to the bottom wall 41C in the height direction (arrow Z4 side). The side wall (first side wall) 45B covers the battery row 31C from one side in the width direction (arrow Y3 side), and the side wall (second side wall) 46B covers the battery row 31C from the side opposite to the side wall 45B in the width direction (arrow Y4 side). The case member (first case member) 35B covers the battery row 31C only from one side in each of the height direction and the width direction, and the case member (second case member) 36B covers the battery row 31C only from the side opposite to the case member 35B in each of the height direction and the width direction.

Each of the partition (first partition) 47C and the partition (second partition) 48C is formed to sandwich each of the batteries 1 of the battery row 31C from both sides in the array direction (depth direction). Thus, each battery 1 of the battery row 31C is sandwiched by corresponding two partition walls (first partition walls) 51C from both sides in the array direction, and sandwiched by corresponding two partition walls (second partition walls) 52C from both sides in the array direction. The boundary between the partitions 47C and 48C is a dividing part B3 that divides the case member (second case member) 36B from the case member (first case member) 35B. The dividing part B3 of the case members 35B and 36D extends along a direction inclined with respect to both the height direction and the width direction of the battery module 30. The dividing part B3 is formed in such a manner that it becomes more distant from the side wall 45B in the width direction as it comes closer to the bottom wall 41C in the height direction.

In the present modification, the partition 47C is provided with ribs (first ribs) 55 in a manner similar to the above-described embodiments, etc. The batteries 1 of the battery row 31C are inserted into the case member 35B along the width direction of the battery module 30 in a state of being inserted into the case member 36B. Therefore, the workability of work of inserting the batteries 1 of the battery row 31B into the case member 35B is improved in a manner similar to the above-described embodiments, etc.

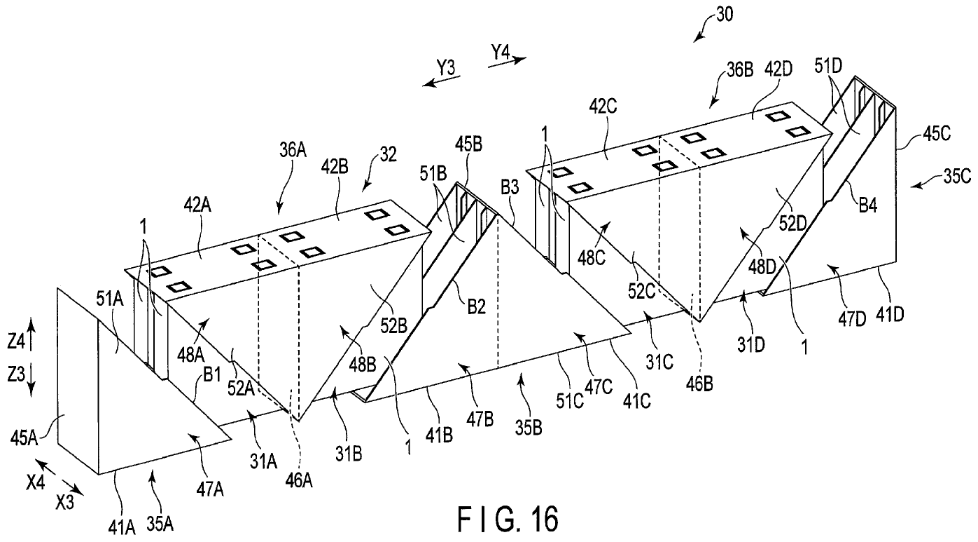

In the fifth modification illustrated in FIG. 16, four battery rows 31A to 31D are provided in the battery module 30. Each of the battery rows 31A to 31D includes two batteries 1. In this modification as well, an array direction of each of the battery rows 31A to 31D corresponds to or substantially corresponds to the depth direction (direction indicated by arrows X3 and X4) of the battery module 30. FIG. 16 is a perspective view of the battery module 30.

In the present modification, the case members (first case members) 35A to 35C are members corresponding to the case members (35;35A,35B) of the above-described embodiments, etc., and the case members (second case members) 36A and 36B are members corresponding to the case members (36;36A,36B) of the above-described embodiments, etc. FIG. 15 shows a state in which the case members 35A to 35C, 36A, and 36B are separated from each other. The bottom walls 41A to 41D are sites corresponding to the bottom walls (41;41A-41C) of the above-described embodiments, etc., and the top walls 42A to 42D are sites corresponding to the top walls (42;42A-42C) of the above-described embodiments, etc. The side walls (first side walls) 45A to 45C are sites corresponding to the side walls (45;45A,45B) of the above-described embodiments, and the side walls (second side walls) 46A and 46B are sites corresponding to the side walls (46;46A,46B) of the above-described embodiments, etc.

In the present modification, the partitions (first partitions) 47A to 47D are sites corresponding to the partitions (47;47A-47C) of the above-described embodiments, and the partitions (second partitions) 48A to 48D are sites corresponding to the partitions (48;48A-48C) of the above-described embodiments, etc. The partition walls (first partition walls) 51A to 51D are sites corresponding to the partition walls (51;51A-51C) of the above-described embodiments, and the partition walls (second partition walls) 52A to 52D are sites corresponding to the partition walls (52;52A-52C) of the above-described embodiments, etc. The dividing parts B1 to B4 are parts corresponding to the dividing parts (B;B1-B3) of the above-described embodiments, etc. Thus, the present modification also exhibits similar advantageous effects to those of the above-described embodiments, etc.

According to at least one of the embodiments and examples, the first case member covers the battery row only from one side in each of the height direction and the width direction, and the second case member covers the battery row only from the side opposite to the first case member in each of the height direction and the width direction. The first partition and the second partition are each formed to sandwich each of the batteries from both sides in the array direction. Each of the first ribs protrudes toward a corresponding one of the batteries in the first partition in a state of being compressed by a corresponding one of the batteries. The boundary between the first partition and the second partition is a dividing part that divides the second case member from the first case member. Therefore, it is possible to provide a battery module in which each of batteries is fixed inside a case and the workability of assembling work is improved, and a method of producing the battery module.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A battery module, comprising:
a battery row including a plurality of batteries arrayed; and
a case in which the battery row is housed,
the case comprising:
a first case member covering the battery row only from one side in each of a height direction intersecting an array direction of the battery row and a width direction intersecting both the array direction and the height direction; and
a second case member coupled to the first case member, and covering the battery row only from a side opposite to the first case member in each of the height direction and the width direction,
the first case member comprising:
a first partition formed to sandwich each of the batteries from both sides in the array direction; and
first ribs, one or more of the first ribs being provided for each of the batteries, and each of the first ribs protruding toward a corresponding one of the batteries in the first partition in a state of being compressed by the corresponding one of the batteries,
the second case member comprising a second partition formed to sandwich each of the batteries from both sides in the array direction, wherein a boundary between the first partition and the second partition is a dividing part that divides the second case member from the first case member.

2. The battery module of claim 1, wherein the boundary between the first partition and the second partition extends along a direction inclined with respect to both the height direction and the width direction.

3. The battery module of claim 1, wherein
the first case member comprises:
a bottom wall which covers the battery row from one side in the height direction, and to which the first partition is connected; and
a first side wall which covers the battery row from one side in the width direction, and to which the bottom wall and the first partition are connected,
the second case member comprises:
a top wall which covers the battery row from a side opposite to the bottom wall in the height direction, and to which the second partition is connected; and
a second side wall which covers the battery row from a side opposite to the first side wall in the width direction, and to which the top wall and the second partition are connected, and
the boundary between the first partition and the second partition is formed to become more distant from the first side wall as the boundary comes closer to the bottom wall.

4. The battery module of claim 3, wherein the first case member includes second ribs, one or more of the second ribs being provided for each of the batteries, and each of the second ribs protruding toward a corresponding one of the batteries in the first side wall in a state of being compressed by the corresponding one of the batteries.

5. The battery module of claim 1, wherein the one or more first ribs are arranged at a position deviated from other first ribs in the width direction.

6. The battery module of claim 1, further comprising a fastening member that fastens the first case member to the second case member to apply a fastening force in a direction intersecting the width direction.

7. A manufacturing method of the battery module of claim 1, the manufacturing method comprising:
inserting the batteries into the second case member in such a manner that the second case member covers the battery row only from one side in each of the height direction and the width direction and the second partition sandwiches each of the batteries from both sides in the array direction;
inserting the batteries into the first case member along the width direction from an end opposite to a side in which the second case member covers the battery row in the width direction in a state where the batteries are inserted into the second case member;
inserting the batteries into the first case member along the width direction in a state where the first partition sandwiches each of the batteries from both sides in the array direction, thereby compressing each of the first ribs by a corresponding one of the batteries; and
coupling the first case member to the second case member in a state where the batteries are inserted into the first case member, and assembling the case in such a manner the first case member covers the battery row only from a side opposite to the second case member in each of the height direction and the width direction and a boundary between the first partition and the second partition is a dividing part that divides the second case member from the first case member.
